(19) United States
(12) Patent Application Publication
(10) Pub. No.: US 2018/0113960 A1
(43) Pub. Date: Apr. 26, 2018

(54) SYSTEM, METHOD, AND APPARATUS FOR ANALYZING NON-LINEAR SITE-STRUCTURE INTERACTION

(71) Applicant: Battelle Energy Alliance, LLC, Idaho Falls (ID)

(72) Inventors: Justin Coleman, Idaho Falls, ID (US); Chandrakanth Bolisetti, Idaho Falls, ID (US)

(21) Appl. No.: 15/789,796

(22) Filed: Oct. 20, 2017

Related U.S. Application Data
(60) Provisional application No. 62/411,241, filed on Oct. 21, 2016.

(51) Int. Cl. G06F 17/50; G06F 3/0484

(52) U.S. Cl. CPC G06F 17/5004; G06Q 50/265; G06F 3/04847

(57) ABSTRACT

Systems, methods and apparatuses for analyzing the non-linear effects of a seismic load on a structure are disclosed. A system includes software instructions for enabling a computer to provide a site model, provide a structure model, and provide a site-structure interface model; receive one or more parameters associated with at least one of the site model, the structure model, and the site-structure interface model; generate a combined model based at least in part on the site model, structure model, site-structure interface model and the one or more parameters; and generate a response associated with the combined model based on an external load.

### CROSS-REFERENCE TO RELATED APPLICATIONS

This application claims the benefit under 35 U.S.C. § 119(e) of U.S. Provisional Patent Application Ser. No. 62/411,241, filed Oct. 21, 2016, entitled “SYSTEM, METHOD, AND APPARATUS FOR ANALYZING NON-LINEAR SITE-STRUCTURE INTERACTIONS,” the entire contents and disclosure of which is incorporated herein by this reference.

### SPONSORED RESEARCH OR DEVELOPMENT

The invention was made with government support under Contract No. DE-AC07-05-ID14517, awarded by the United States Department of Energy. The government has certain rights in this invention.

### TECHNICAL FIELD

The present invention relates generally to systems, methods, and apparatuses for analyzing site-structure interaction, and more particularly, to a system, method, and apparatus for analyzing the non-linear interaction between a site and a structure.

### BACKGROUND

Analytical tools for calculating and modeling structure behavior (e.g., strain and stress) under the loads created by external hazard events (such as seismic) are known in the art. Such tools, for example, have been used to model the effects of earthquakes and floods/tsunamis on nuclear facilities, dams, bridges, and skyscrapers. The software tools widely used in industry model structural behavior and performance using linear analysis techniques. These conventional seismic analysis tools are used in deterministic calculations and are not integrated with hazard or risk analyses.

Conventional linear seismic analysis tools poorly predict structure performance during large amplitude seismic events. For large amplitude seismic events, the linear seismic analysis tools may under-estimate the performance of a structure, which may lead to overly conservative structure designs. Further, for large amplitude seismic events the conventional linear seismic analysis tools typically do not directly model non-linear performance and so, for example, do not model soil-structure separation and time-based phenomena that correlate to failures of a structure. Geometric and material nonlinearities that are poorly modeled by linear seismic analysis tools include opening and closing of gaps at the soil-structure interface, as well as elasto-plasticity and damage of soil, rock and structure. Thus, the non-linearities may be missed or misunderstood, and structures inappropriately designed—in many cases, over designed in terms of performance.

Though linear seismic analysis tools are poor predictors, they were and still are used in industry to approximate nonlinear structural responses of structure performance.

Some software tools are available for time-domain analysis of structures using finite-element analysis, such as ABAQUS (Dassault Systemes), and ANSYS (Ansys, Inc.), and LS-DYNA (LSTC 2013). The existing tools typically require manually building a soil domain model and an application of a load.

Poor performance modeling may lead to misunderstanding of risk. A misalignment between design and risk may lead to inefficiency in the cost to build a structure. The inefficiencies also affect maintenance cost and insurance costs for such structures.

Other problems and drawbacks also exist for conventional seismic analysis tools.

Accordingly, there is a need for seismic analysis tools that automate the generation of models as well as capture the geometric non-linearities at the structure-soil interface and their effect on the performance of a structure under various loads.

### BRIEF SUMMARY

According to a first embodiment of the disclosure there is provided a computer system adapted to analyze an effect of a load on a structure. The computer system includes at least one processing core; and at least one non-transitory storage medium including software instructions. The software instructions are adapted to enable the computer system to provide a site model; provide a structure model; provide a site-structure interface model; receive one or more parameters associated with at least one of the site model, the structure model, and the site-structure interface model; generate a combined model based at least in part on the site model, structure model, site-structure interface model and the one or more parameters; and generate a response associated with the combined model based on an external load.

According to one aspect of this embodiment of the disclosure the software instructions are further adapted to enable the computer system to receive one or more properties corresponding to a site; generate one or more finite soil elements based on the site properties, an element size, and a frequency cut-off; and mesh the one or more finite soil elements to generate the site model.

According to another aspect of this embodiment of the disclosure the one or more site properties are embodied in a cross-sectional image of the site.

According to one aspect of this embodiment of the disclosure the one or more site properties comprise soil properties corresponding to the site.

According to one aspect of this embodiment of the disclosure the external load is based on at least one of a seismic force history for a site associated with the site model and an impulse force associated with an earthquake source.

According to one aspect of this embodiment of the disclosure the software instructions are further adapted to enable the computer system to generate one or more seismic force histories from one or more acceleration histories of a site associated with the site model.

According to one aspect of this embodiment of the disclosure the software instructions are further adapted to enable the computer system to import one or more of the site model, the structure model, and the site-structure interface model.

According to one aspect of this embodiment of the disclosure the combined model is a nonlinear soil-structure interaction model.

According to one aspect of this embodiment of the disclosure the combined model comprises at least one of a non-linear material behavior and a nonlinear geometric behavior.

According to one aspect of this embodiment of the disclosure the generated response is in the frequency domain or the time domain.

In another embodiment, of the present disclosure there is provided a computer program product for enabling a computer to analyze an effect of a load on a structure. The computer program product may include a computer-readable non-transitory memory; and software instructions on the memory. The software instructions may be adapted to enable a computer to perform the operations of: provide a site model; provide a structure model; provide a site-structure interface model; receive one or more parameters associated with at least one of the site model, the structure model, and the site-structure interface model; generate a combined model based at least in part on the site model, structure model, site-structure interface model and the one or more parameters; and generate a response associated with the combined model based on an external load.

According to one aspect of this embodiment of the disclosure the software instructions on the memory are further adapted to enable a computer to present a graphical user interface at a display, the graphical user interface comprising regions that display information associated with the site model, structure model, site-structure interface model, the combined model, and the generated response.

According to another embodiment of the present disclosure there is provided a user-interface for facilitating user interaction with a computer system to analyze an effect of a load on a structure. The user interface may be invocable by an application program adapted to control the user interface based on user manipulation of the user interface. The user interface may comprise one or more display regions and one or more activatable regions. The one or more displays may include one or more selectable site parameters; one or more selectable structure parameters; one or more selectable site-structure interface parameters; one or more selectable load parameters; and a response information based on a response analysis. The one or more activatable regions, upon activation may invoke the response analysis based on an activated region, selected site parameters, selected structure parameters, selected site-structure interface parameters, and selected load parameters.

According to one aspect of this embodiment of the disclosure the activated region corresponds to a component of a structure.

According to one aspect of this embodiment of the disclosure the one or more display regions further comprise information about a combined model, the combined model based on the selected site parameters, selected structure parameters, and selected site-structure interface parameters.

According to one aspect of this embodiment of the disclosure the displayed information about the combined model comprises a graphical representation of a site and a structure.

According to one aspect of this embodiment of the disclosure the graphical representation of the combined model comprises at least one of the activatable regions.

According to one aspect of this embodiment of the disclosure the response information comprises a graphical representation of at least one of a material non-linear response and a geometric nonlinear response of a structure.

According to one aspect of this embodiment of the disclosure the graphical representation of the response information comprises a displacement in the time domain.

According to one aspect of this embodiment of the disclosure the graphical representation of the response information comprises a displacement in the frequency domain.

According to one aspect of this embodiment of the disclosure the application program is a web-application or a client-application executing in a browser.

According to one aspect of this embodiment of the disclosure the application program is configured to control the user-interface such that at least two display regions are displayed contemporaneously.

According to one aspect of this embodiment of the disclosure the application program is configured to control the user-interface such that the display regions are added and removed from the user interface according to a workflow.

According to another embodiment of the present disclosure there is provided a computer-implemented method of analyzing an effect of a load on a structure. The method may include: providing a site model; providing a structure model; providing a site-structure interface model; receiving one or more parameters associated with at least one of the site model, the structure model, and the site-structure interface model; generating a combined model based at least in part on the site model, structure model, site-structure interface model and the one or more parameters that models at least one of a geometric and a non-linear behavior; and generating a response associated with the combined model based on an external load.

The foregoing and other features and advantages of the present disclosure will be made more apparent from the descriptions, drawings, and claims that follow. One of ordinary skill in the art, based on this disclosure, would understand that other aspects and advantages of the present disclosure exist.

### BRIEF DESCRIPTION OF THE DRAWINGS

The applications and advantages of one or more embodiments of the present disclosure will be apparent to one of ordinary skill in the art from the summary and detailed description in conjunction with the appended drawings. The patent or application file contains at least one drawing executed in color. Copies of this patent or patent application publication with color drawing(s) will be provided by the Office upon request and payment of the necessary fee.

FIG. 1 is a block-diagram of a computer system configured to analyze the non-linear effects of a seismic load on a structure in accordance with an embodiment of the disclosure.

FIG. 2 is a block-diagram of a computer system configured to analyze the non-linear effects of a seismic load on a structure in accordance with an embodiment of the disclosure.

FIG. 3 is a flow-chart of a process for using a computer system to analyze the non-linear effects of a seismic load on a structure in accordance with an embodiment of the disclosure.

FIG. 4 is a block-diagram of a computer system configured to perform probabilistic simulation of a risk of failure at a site from seismic load, in accordance with an embodiment of the disclosure.

FIG. 5 is a flow-chart of a process for performing computer-aided probabilistic simulation of a risk of failure at a site from seismic load, in accordance with an embodiment of the disclosure.

FIG. 6 is an illustration of a computer generated graphical representation of a combined soil-structure model, in accordance with an embodiment of the disclosure.

FIG. 7 is a graphical representation of a soil domain mesh generated by a computer from a cross-sectional image of a site, in accordance with an embodiment of the disclosure.

FIG. 8 is an illustration of a graphical user interface for controlling the generation of, and viewing, the various models described herein, in accordance with an embodiment of the disclosure.

FIG. 9 is an illustration of a system for risk analysis based on analysis of non-linear effects of a load, in accordance with an embodiment of the disclosure.

### DETAILED DESCRIPTION

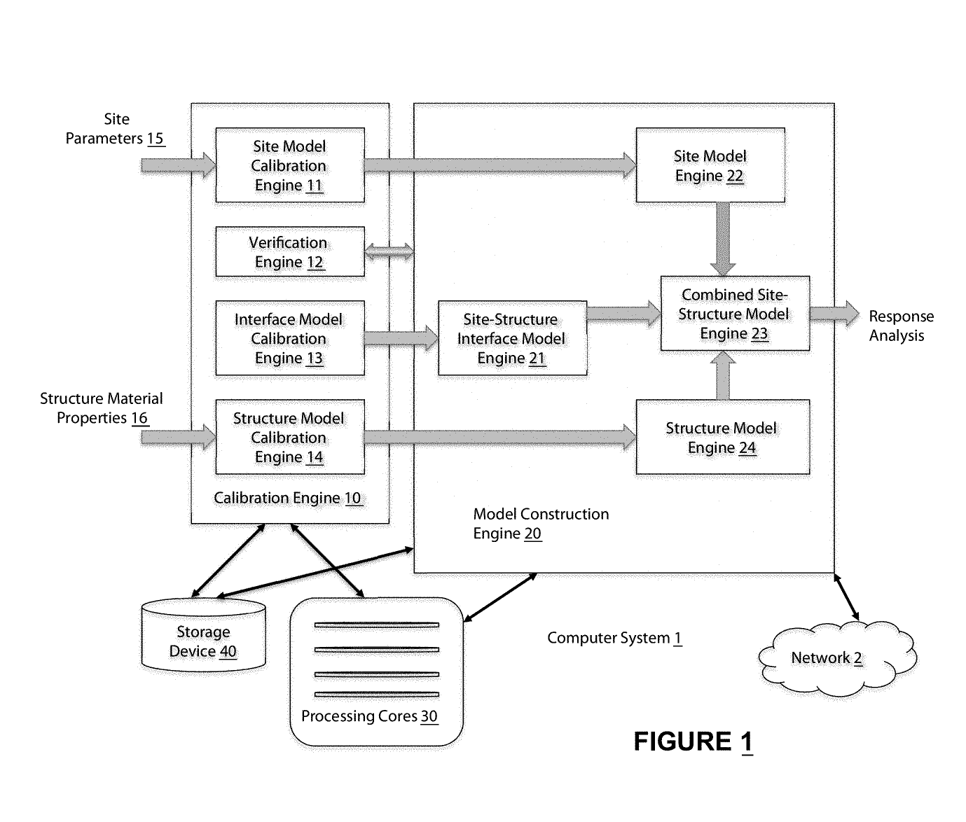

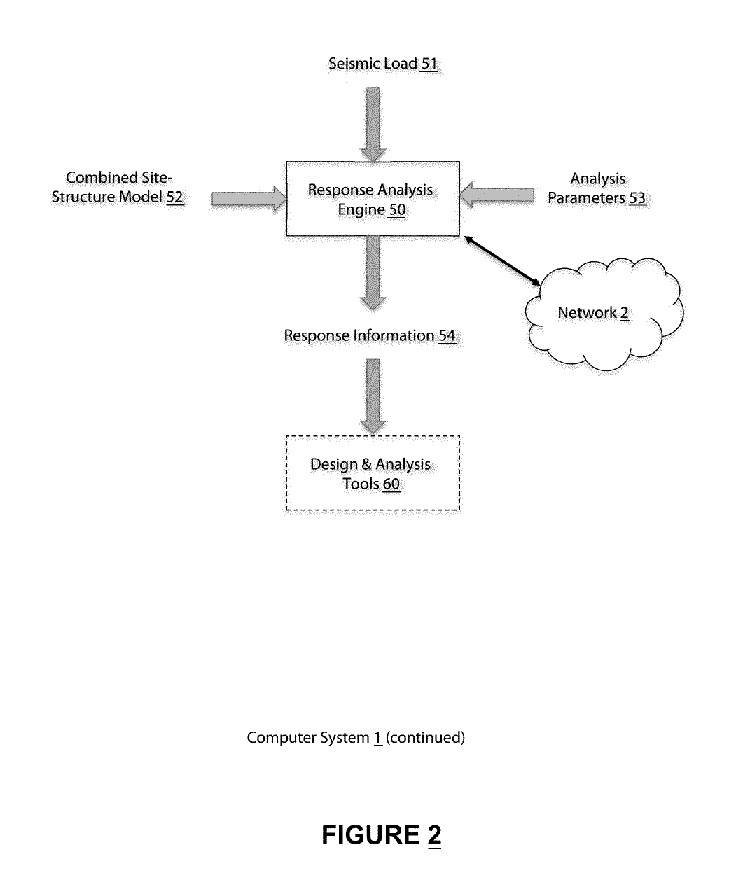

An embodiment of a Computer System 1 is illustrated in FIGS. 1 and 2. Here, the term “computer system” is to be understood to include at least one non-transitory computer-readable memory and at least one processing unit, and is illustrated as such in FIG. 1. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice of this invention that the memory and the processor be physically located in the same place. That is to say, it is foreseen that the processor and the memory might be distributed among physical pieces of equipment or even in geographically distinct locations.

The processing unit may be a general purpose “central processing unit,” but may utilize a wide variety of other technologies and specific purpose hardware may be used to implement the exemplary embodiments described herein, including a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention. The processing unit may consist of a single core, or may be a multi-core processor that has two or more processing units that can operate executing instructions independently in parallel.

Some advantages of embodiments of the present disclosure include providing for integrated software tools on a common platform for determining multi-hazard risk, including seismic and flooding. The tools may utilize a common calculation approach form multi-hazard risk. The tools may also include automated risk calculation packages for automated risk analysis and feedback.

The computer system 1 illustrated in FIGS. 1 and 2 may include a Calibration Engine 10, a Model Construction Engine 20, and a Response Analysis Engine 50 (FIG. 2). The system also may include one or more Processing Cores 30, and one or more Storage Devices 40.

The terms “module(s)” and “engine(s)” when used herein refer to the logic, embodied in hardware and/or software, to accomplish the features, functions, tasks or steps described herein. In the case of a general-purpose computer, the “modules” and “engines” may be embodied in software classes and applications executed by processor cores, and while the modules or engines are executing the general purpose computer may be thought of as a special purpose computer or a specific purpose computer. The “modules” and “engines” may also relate to a specific purpose hardware including the firmware and machine code controlling its operation.

Further, when embodied in software, the engine(s) that enable a computer system to act in accordance with the embodiments of the present disclosure may be provided in any number of language forms including, but not limited to, original source code, assembly code, object code, machine language, compressed or encrypted versions of the foregoing, and any and all equivalents. Some examples of programming languages that may be used to write the software include, but are not limited to, C, C++, JAVA, MATLAB, MINITAB, EXPRESS, DRAKON, DYNA, PYTON, MOOSE, and RUBY. The software programs may be further translated into machine language or virtual machine instructions and stored in a program file in that form. The program file may then be stored on or in one or more of the articles of manufacture.

Memories, such as Storage Device 40, may be arranged inside and outside a computer. For example, in a network, the system memory may include (or be part of) a distributed storage system that provides both storage and file-system, such as network-attached-storage (NAS), or a distributed storage system that provides only storage, such as a storage-area-network (SAN). In the case of NAS, it may include software capable of file management services, including, without limitation, FreeNAS™, NASLite™, and NexentaStor™. The NAS may contain one or more hard disks, arranged into logical, redundant storage containers or RAID arrays. The NAS may utilize one or more file-based protocols including, without limitation, Network File System (NFS), Windows NT™File System (NTFS), File Allocation Table (FAT), Server Message Block/Common Internet File System (SMB/CIFS), or Apple Filling Protocol (AFP).

The information stored on a memory such as Storage Device 40 may be stored in a database as data. The particular architecture of the database may vary according to the specific type of data, mode of access of the data, or intended use of the data stored in the database; including, without limitation, a row-oriented data-store architecture, a column-based database management system, extensible-markup language, a knowledgebase, a frame database, or combinations thereof. A database management system (DBMS) may organize the storage of the data in the database, tailored for the specific requirements of the present system. The DBMS may use any number of query languages to access the database, including, without limitation, structured query language (SQL). In the case of SAN, embodiments of the invention may use any number of protocols to communicate between server and storage, including, without limitation, the SCSI protocol, HyperSCSCI protocol, iSCSI protocol, ATA over Ethernet, Fibre channel Protocol, and Fibre Channel over Ethernet.

Turning to FIG. 1, Calibration Engine 10 manages the selection of parameters for, and the calibration of, the site model, the site-structure interface model, the structure model, and the combined site-structure model. Calibration Engine 10 may include a Site-Model Calibration Engine 11, A Verification Engine 12, an Interface-Model Calibration Engine 13, and a Structure Model Calibration Engine 13.

The Site Model Calibration Engine 11 manages the calibration of a site modal and may accept Site Parameters 15. In one embodiment, the Site Parameters 15 may include soil parameters including data about the soil properties associated with the site or planned site of a structure. The soil data may be generated from geotechnical analysis of the mechanical properties of soil samples collected at the site. The specific soil properties that are analyzed may be based on the expected deformation of the soil layers below the structure and the composition of the soil.

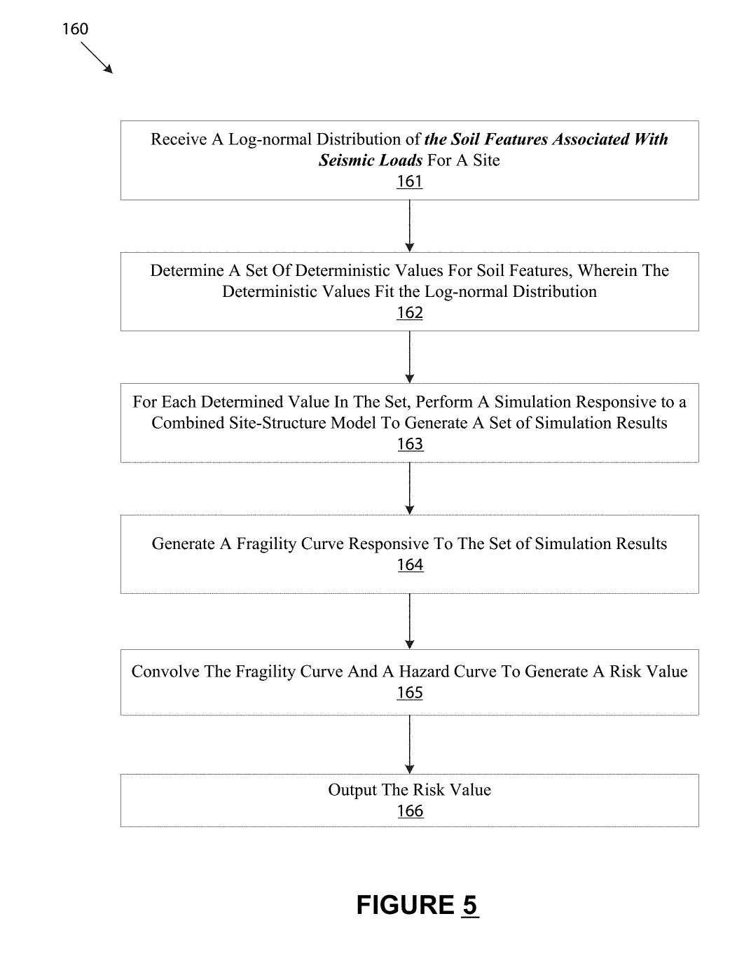

In one exemplary embodiment, the Site Parameters 15 may be embodied in a cross-sectional image of a soil domain, and one or more image characteristics (including in the frequency domain) correspond to the soil's composition. As a non-limiting example, the cross-sectional image may be one or more of a .png, .jpeg, .gif, .tif, and a .bmp. An example of a soil-domain mesh generated from an image in accordance with an embodiment of the disclosure is illustrated in FIG. 5. The Site Model Calibration Engine 11 may determine mechanical characteristics of the soil domain based on the soil composition. In one embodiment, the Site Model Calibration Engine 11 may have a priori information about the image characteristics, and in another embodiment, it receives the information in a file. In another embodiment, the Site Parameters 15 may be determined from a topology analysis of a site.

In addition to soil parameters, the Site Parameters 15 may include a site domain size and/or boundary and parameters related to finite element (FE) analysis and meshing for construction of a site model. FE related parameters may include one or more of an element size, element formulation (e.g., constant strain, fully integrated), integration technique (e.g., implicit or explicit), and a desired maximum/cut-off frequency for analysis. One or more of the Site Parameters 15 may be automatically determined by the Site Model Calibration Engine 11. For example, the element size may be a function of soil properties. In one embodiment, Site Parameters 15 may be based on default values. The default values may be based on typical soil properties or from analyzed soil properties that were collected relating to the construction of a different site model. Site Parameters 15 may include the vertical and horizontal dimensions of the soil domain. In one embodiment, the Site Model Calibration Engine 11 will automatically determine the vertical and horizontal dimensions of the soil domain that satisfy the conditions of (i) the response of the soil domain at the edge of the domain is not significantly different from the free-field response calculated from one-dimensional site-response analysis; and (ii) the in-structure response does not change significantly with a future increase in the lateral dimension. Considerations for the vertical dimension of the soil domain may include: (i) the depth at which the ground motion is defined; and (ii) the depth sufficient to capture the vertical dynamic stiffness of the foundation. Considerations for the lateral boundaries of the soil domain may include the boundaries which will significantly dissipate the arriving scattered waves.

In one embodiment, a previously meshed site model that satisfies the FE parameters may be imported into the Site Model Calibration Engine 11 and calibrated.

The Verification Engine 12 manages calibration for verification and benchmarking of a combined site structure model. The Verification Engine 12 may receive benchmarking data to which the behavior of the site model, structure model, site-structure interface model, and the combined structure model may be compared. In some situations, the hardware architecture or the software language used for the Calibration Engine 10 and Model Construction 20 may result in differences in the FE analysis of the models. Therefore, the validation, verification and benchmarking performed by the Verification Engine 12 will indicate if the Computer System 1 performs within acceptable ranges. Examples of activities performed by the Verification Engine 12 include:

Calibrating, verifying, and validating the constitutive model(s) of soils for NLSSI analysis. In one embodiment, calibration of constitutive model(s) of the soil is performed through analysis of a single element or a small number of elements, for example, eight-node solids.

Verifying the soil domain model for material properties and boundary conditions. In one embodiment, verification is performed by comparing the response of the free-field soil domain model (without a structure) with equivalent linear site-response analysis codes at low levels of input ground motion.

Calibrating, verifying and validating constitutive models of structural components. In one embodiment, calibration, verification and validation are performed using single elements and three-dimensional loadings.

Analyzing and benchmarking a fixed-base structural model for (a) static loading to confirm expected seismic load paths; (b) dynamic properties (e.g., modal frequencies, modal participation factors, model shapes, and modal damping ratios). In one embodiment, results from analysis of the fixed-base structural model may be compared with those from analysis of simpler models used for preliminary design and assignment.

Verifying the soil-foundation (i.e., the soil-structure) interface for a selected sliding and gapping behavior through the application of force and/or displacement functions.

Benchmarking the full NLSSI model after it is assembled from the soil model, structure model and soil-structure interface model. In one embodiment, benchmarking includes calculating modal frequencies and modal participation factors and comparing the results with analysis of a SASSI (System for Analysis of Soil-Structure Interaction)-type model of the soil-structure system for low amplitude ground motion inputs for which linear response is anticipated.

The Verification Engine 12 may automatically or with user direction provide the results of the analysis, verification, validation, and benchmarking to the Site Model Calibration Engine 11, Interface Model Calibration Engine 13, and the Structure Model Calibration Engine 14 for further calibration of the parameters used to generate the Site Model, the Structure Modal, the Site-Structure Interface Model, and the Combined Site-Structure Model.

The Interface Model Calibration Engine 13 manages the calibration of the Site-Structure Interface Model, including receiving and selecting parameters, as we as automatically generating parameters. In one embodiment, the interface model is a soil-foundation interface model.

The Structure Model Calibration Engine 14 manages the calibration of the Structure Model, including receiving Structure Material Properties 16. Structure Material Properties 16 may include characteristics such as shear and strain for components of the structure. Parameters may also include the type of material of the component materials (steel, concrete, wood, etc.). The Structure Model Calibration Engine 14 may include stored characteristics for component materials for use as default parameters. In one embodiment, the Structure Material Properties 16 may be imported as a structure model in Solid Works or Auto Cad format. The imported model may include linear elements. The calibration of the structure model may include linear and non-linear components. An FE structure may be built using linear shell, solid, and beam-column elements for components of the structure.

In one embodiment, a previously meshed site-structure interface model that satisfies the FE parameters may be imported into the Interface Model Calibration Engine 13 and calibrated.

The Model Construction Engine 20 manages the construction of the site-structure model, site-model, structure model, and combined site-structure model. The Model Construction Engine 20 may include a Site Model Engine 22, a Site-Structure Interface Model Engine 21, a Structure Model Engine 24, and a Combined Site-Structure Model Engine 23.

The Site-Structure Interface Model Engine 21 manages generation of a site-structure interface model based, in part, on a combination of parameters received from the Interface Model Calibration Engine 13. In a first embodiment the soil-foundation interface model may be one or more contact elements for FE. In a second embodiment the soil-foundation interface model may be one or more nonlinear springs and dashpots connected between the soil and foundation nodes that have zero strength in tension and simulate the frictional behavior in shear. In a third embodiment the soil-foundation interface model may be one or more thin layers of nonlinear hysterics soil that have zero strength in tension and a peak shear strength to simulate friction.

The Site Model Engine 22 manages generation of a site-structure interface model based, in part, on a combination of parameters received from the Site Model Calibration Engine 11. In one exemplary embodiment the site model is a model of the soil domain and is generated by an FE mesh operation. The mesh may be sufficiently fine to transmit seismic motions through the soil domain up to a cut-off frequency parameter. In one embodiment, an element size is used that is less than the small-strain shear-wave velocity divided by 10 times the cut-off frequency (i.e., discretizing the harmonic wave at the cut-off frequency into tenths). Finer mesh elements may be used based on the mechanical characteristics of the soil components. In one embodiment, element sizes may be calibrated based on the results of one or more mesh sensitivity studies.

The Structure Model Engine 24 manages generation of the structure model based, in part, on a combination of parameters received from the Structure Model Calibration Engine 14. In one embodiment, the Structure Model Engine 24 consists of translating a structure model from a first format (e.g., Solid Works format), to a second format (e.g., LS-DYNA). The Structure Model Engine 24 may perform a mesh operation on FE elements to form the structure. The mesh may be performed to enable resolution of forces and deformations in noted critical regions of the structure and for critical components of the structure.

The Combined-Site Structure Model Engine 23 manages the generation of the combined site-structure model. The Combined-Site Structure Model Engine 23 generates the combined-site structure model from a mesh of the site model, structure model, and site-structure interface model.

The Model Construction Engine 20 may enable benchmarking, calibration, validation and verification of the site model, structure model, site-structure interface model and combined site-structure model relating to the Verification Engine 12. Results may be used to re-calibrate the parameters of the models and in some cases initiate regeneration of the models until the results satisfactory, for example, substantially meeting or exceeding certain threshold operational requirements, user acceptance criteria, or the like.

Turning to FIG. 2, the Computer System 1 may also include (as noted above) a Response Analysis Engine 50. The Response Analysis Engine 50 manages the analysis of the effect of a Seismic Load 51 on components or elements of the Combined Site-Structure Model 52 based on Analysis Parameters 53. The Seismic Load 51 may include one or more of an impulse force associated with a seismic source (e.g., an earthquake) or a seismic force history for a site associated with constituent site model. In one embodiment, seismic force histories for a site are generated from acceleration histories for the site. The Analysis Parameters 53 may include the component or element of the Combined Site-Structure Model 52 to be analyzed, the location at which the load is applied (e.g., the base of the soil domain), types of ground motions that be used (e.g., an outcrop motion, a within motion, etc.), and gravity loads.

The Response Analysis Engine 50 may generate Response Information 54 about the effect of the Seismic Load 51 on structure, soil and components and regions thereof. Among the effects are nonlinear material effects and nonlinear geometric effects. Nonlinear material effects include soil, rock, and contact elasto-plasticity and damage. Nonlinear geometric effects include gaps opening and closing and sliding between the foundation of a structure and the soil. In additional to structural information, design information may also be provided in the Response Information 54 on a component-by-component basis, such as time-to-failure, operational frequency range, and the like.

In one embodiment, the Response Information 54 may be provided to additional Design & Analysis Tools 60. The Design & Analysis Tools 60 may be additional packages within the Computer System 1, or they can be separate software tools. Functions and features of Design & Analysis Tools 60 may include software tools for structure design.

It is specifically contemplated that the Computer System 1, and its component engines and modules, may be in communication with a Network 2 illustrated in FIG. 1. In one embodiment, the component modules and engines of Computer System 1 are distributed geographically and communicate while performing the operations described herein over the Network 2. In another embodiment, some or all of the elements of the Computer System 1 are hosted on the public cloud or on a server, and users may interact with those elements of the Computer System 1 via a client application over the Network 2.

Embodiments of the Network 2 may be implemented in forms including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include BLUETOOTH®, ZIGBEE®, IrDa or other suitable protocol. Furthermore, components of the system may communicate through a combination of wired or wireless paths.

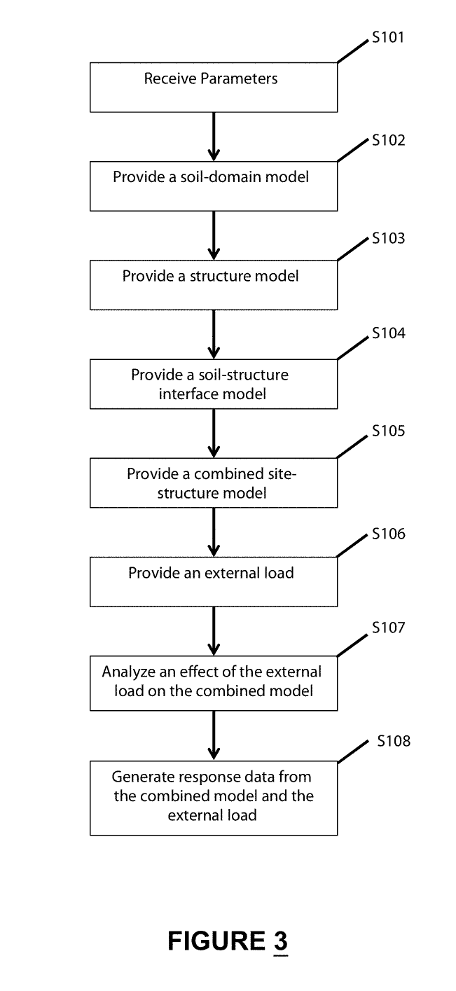

An example of a Process S100 for analyzing the effect of a seismic load on a structure will now be described relating to FIG. 3. The Process S100 illustrated in FIG. 3 is performed relating to a facility (such as a nuclear facility), but those of ordinary skill in the art will recognize that process S100 could be modified for use with dams, bridges, skyscrapers and other structures. The Process S100 may be performed by a computer system such as the Computer System 1.

According to the Process S100, a soil-domain model (S102), a structure model (S103), and a soil-structure interface model (S104) are provided for a facility. Also provided are parameters (S101) that may be used to generate the soil-domain model, structure model, and soil-structure interface model. The soil-domain model, structure model, and soil-structure interface model may be generated by a mesh of elements for FE analysis.

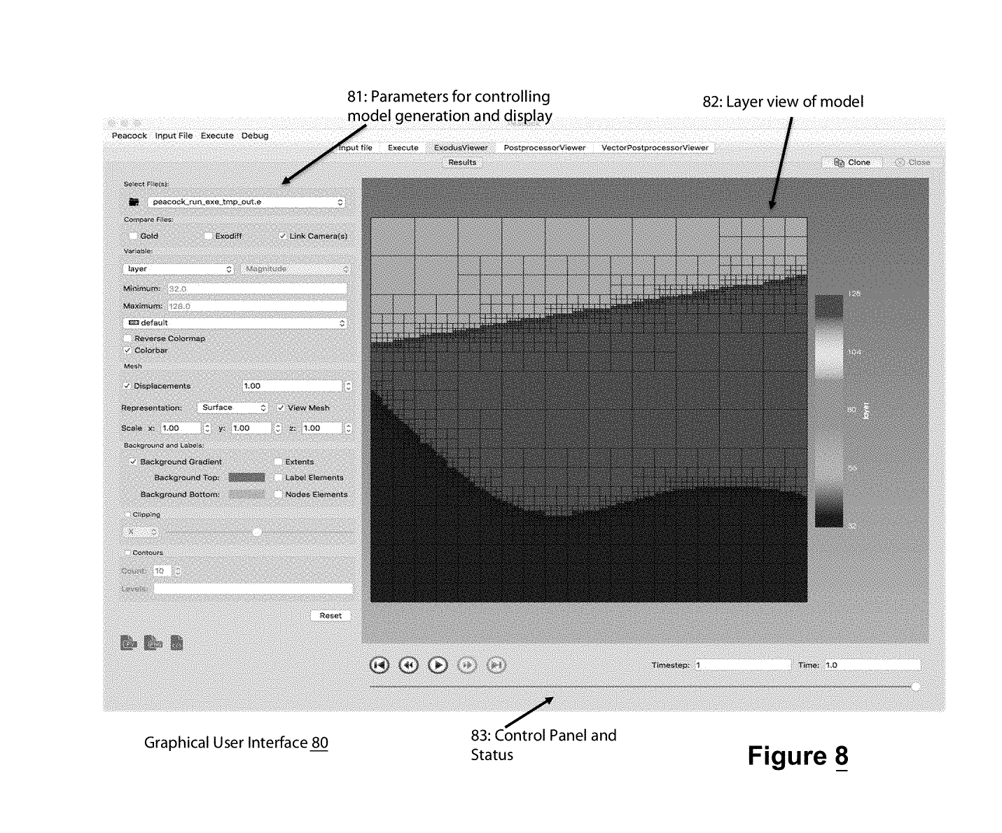

In one embodiment, the parameters may be selected or input by a user via a graphical user interface. The graphical user interface may display screens for each model relating to a workflow. For example, a first interface is displayed for a user to select, enter and/or accept parameters for the soil-model domain; a second interface is displayed for a user to select, enter and/or accept parameters for the structure model; and a third interface is displayed for a user to select, enter and/or accept parameters for the structure-interface model. An example of a graphical user interface 80 in accordance with an embodiment of the disclosure is illustrated in FIG. 8. The interface includes a display region 81 for parameters for controlling model generation and display, a display region 82 for displaying a model, and a display region 83 for a control panel and for status indicators.

The graphical user interface may provide a user feedback from benchmarking, verification, validation and calibration performed automatically as the models are generated based on the parameters. Based on the feedback, the user may select, input, and/or accept additional parameters or to change parameter values. For example, the user may be asked to revise a boundary condition of the soil-domain because the dimensions do not satisfy the conditions for dissipating scattered waves. Parameters may also be added or changed automatically. In one embodiment, the graphical user interface may provide the user with an option to save the soil-domain model, structure model, and soil-structure interface model.

According to the Process 100, a combined soil-structure model is provided (S105). The combined soil-structure model may be formed by a mesh operation of the elements of the soil-domain model, structure model, and soil-structure interface model. A graphical user interface may display the combined-soil-structure model on a screen. Parameters related to generation of the combined soil-structure interface may also be provided by a user via the graphical user interface. A user may also be provided feedback from benchmarking, verification, validation and calibration performed automatically for the combined soil-structure model. Based on the feedback, the user may select, input, and/or accept additional parameters or to change parameter values. Parameters may also be added or changed automatically. In one embodiment, the graphical user interface may provide a user with an option to save a combined model.

Turning back to FIG. 3, according to Process 100 an external load may be provided (S106). The external load may be provided in the form of a seismic force history for a site associated with the site model, an impulse force associated with a seismic event, or a combination there of. In one embodiment, the external load may be provided a cycle of seismic loads. Again, a user may be able to enter parameters associated with the seismic load, including the location of the load. In one embodiment, a user may select a location for the seismic load to be applied on a graphical representation of the combined soil-structure model, for example, clicking on base of the soil domain using a pointer or by selecting it from a list of options.

The seismic load may be analyzed to determine its effect on the combined model (S107). The analysis may be performed on critical regions and components of the structure. For a nuclear reactor, response information about the effect of the seismic load on a control panel, reactor pressure vessel, primary cooling system, and/or steam generators may be determined. Other critical regions may be defined and analyzed. In one embodiment, a graphical user interface may be provided to a user, so that the user may select parameters associated with the analysis of the seismic load. In one embodiment, a user may select components and elements of the structure for analysis by clicking on a graphical representation of the combined model. In another embodiment, the user may select components or elements from a list provided by the graphical user interface.

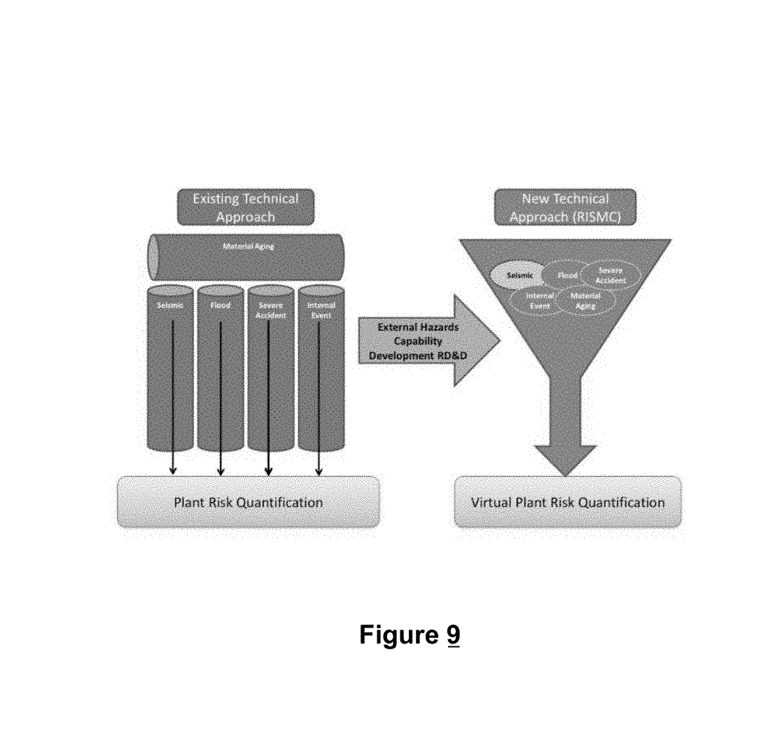

The analysis of the combined model based on the seismic load may generate response data (S108). The response data may be displayed on the graphical user interface. The response data may be reviewed by a user. In one embodiment, the graphical user interface may provide the user with an option to store the response data in a selected format for export to a design tool or to a risk analysis tool(s), including design tools and risk analysis tools that provide for multi-hazard risk quantification, as illustrated in FIG. 9.

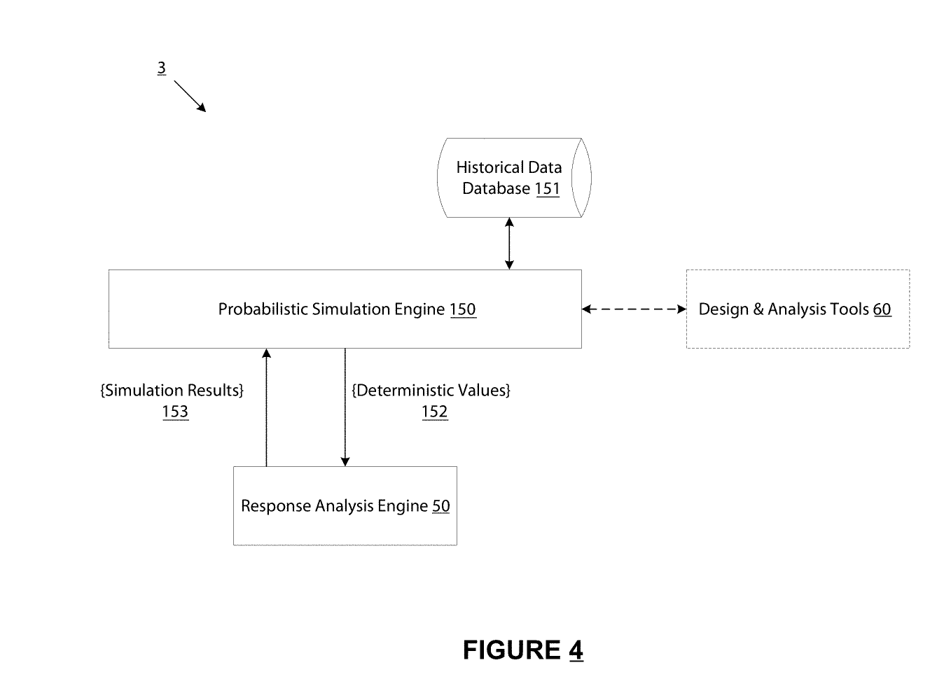

FIG. 4 shows a block-diagram of a computer system 3 configured to perform probabilistic simulation of a risk of failure at a site from seismic load, in accordance with an embodiment of the disclosure. The computer system 3 may include a probabilistic simulation engine 150, a historical data database 151, and a response analysis engine 50. Also shown are design and analysis tools 60, which may be incorporated with the computer system 3 or with another computer system.

The probabilistic simulation engine 150 may be configured to perform a risk analysis of one or more sites responsive to a set of simulation results 153. The historical data database 151 may be configured to store site feature data associated with seismic loads. The site feature data may be, for example, one or more of historical data, field test data, laboratory data, and literature data. In one embodiment, the site feature data may be synthetic data generated to simulate a hazard. The historical data database 151 may also be configured to store one or more hazard curves for site that are indicative of the likelihood of a seismic load of particular magnitude at a site. The historical data database 151 may be configured to store hazard curves for multiple categories of hazards (e.g., earthquake, tsunami, explosion, etc.).

The response and analysis engine 50 may be configured to perform the simulations and generate the set of simulation results 153 responsive to a combined site-stricture model 52 and deterministic values 151. The deterministic values 151 are a set of parameters indicative of soil features associated with a seismic load. Deterministic values, for example, may be the inputs, including soil properties, input acceleration histories, structural properties and the interface properties. The deterministic values 151 may be stored in the historical data database 151 or may be generated by the probabilistic simulation engine 150. In one embodiment functions associated with soil feature parameters may be stored in the historical database 151.

In another embodiment, the probabilistic simulation engine 150 may be configured to generate one or more functions for soil feature parameters responsive to site feature data stored by the historical data database 151. The functions may exhibit a log-normal distribution. The probabilistic simulation engine 150 may generate the deterministic values 151 responsive to the one or more functions or responsive to data points from historical data.

FIG. 5 shows a flow-chart of a process for performing computer-aided probabilistic simulation of a risk of failure at a site from seismic load, in accordance with an embodiment of the disclosure. A set of soil features are received in operation 161. The soil features may be associated with a seismic load at a site, and may have a log-normal distribution. A set of deterministic values for the soil features are determined in operation 162. The deterministic values may fit a log-normal distribution. For each determined value in the set of deterministic values 152, a simulation is performed in operation 163, responsive to a combined site-structure model and the deterministic values. One or more fragility curves may be generated in operation 164 responsive to a set of simulation response. The fragility curve may be indicative of a probability of failure at a site for a given magnitude seismic event. A fragility curve may be convolved with one or more hazard curves in operation 165 to generate a risk value. The risk value may be output in operation 166. Ii various embodiments, the risk value may be stored, output to a reporting system/report, or output to a design and analysis tool.

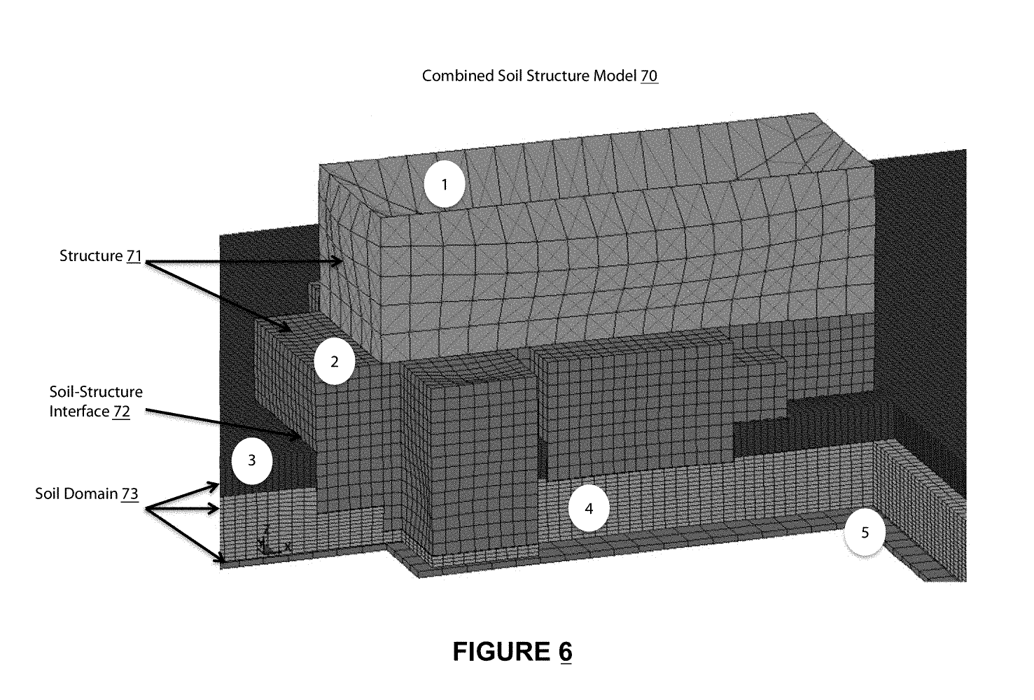

FIG. 6 shows an example of a graphical representation of a Combined Soil-Structure Model 70 generated according to the Process 100. The Combined Soil-Structure Model 70 includes the Soil Domain 73, the Soil-Stricture Interface 72, and the Structure 71. The brown (labeled “1”) and orange (labeled “2”) layers correspond to a Structure 71. The interface between the orange and red layer corresponds to a Soil-Structure Interface 72, and the red (labeled “3”), blue (labeled “4”) and green (labeled “5”) layers correspond to the Soil Domain 73.

A user may enter commands and information into a computer, such as the Computer System 1, or relating to performing the processes described relating to Process 100, through a user interface, including the graphical user interfaces described herein. The user interface may include input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, a virtual port, game port or a universal serial bus (USB) type interface.

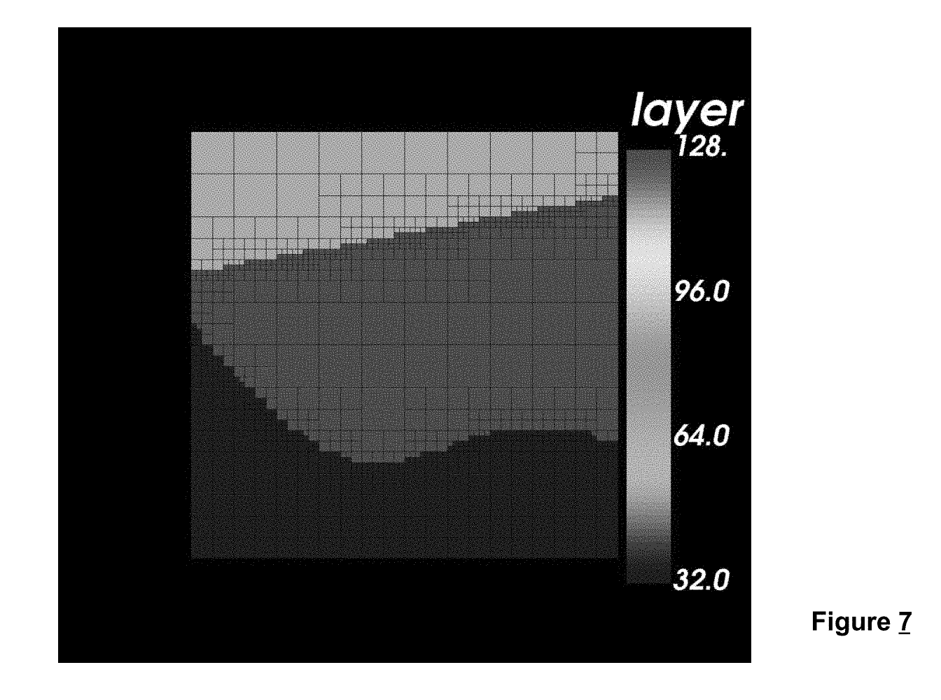

The analysis tool described herein with reference to FIGS. 1 to 9 may be embodied in a computer program product supplied on any one of a variety of computer-readable media. The computer program product may be embodied in computer language statements of the types already described herein.

One of ordinary skill in the art will appreciate that “media,” “medium,” “computer-readable media,” or “computer-readable medium” as used here, may include a diskette, a magnetic tape, a digital tape, a compact disc, an integrated circuit, a ROM, a CD, DVD, Blu-Ray, a cartridge, flash memory, PROM, a RAM, a memory stick or card, or any other non-destructive storage medium useable by computers, including those that are re-writable.

Although the enabling software might be “written on” a disc, “embodied in” an integrated circuit, “carried over” a communications circuit, “stored in” a memory chip, or “loaded in” a cache memory, it will be appreciated that, for the purposes of this application, the software will be referred to simply as being “in” or “on” the computer-readable medium. Thus, the terms “in” or “on” are intended to encompass the above mentioned and all equivalent and possible ways in which software can be associated with a computer-readable medium.

For the sake of simplicity, therefore, the term “computer program product” is thus used to refer to a computer-readable medium, as defined above, which has on it any form of software to enable a computer system to operate according to any embodiment of the invention. Software applications may include software for facilitating interaction with software modules, including user interface and application programming interfaces. Software may also be bundled, especially in a commercial context, to be built, compiled and/or installed on a local computer.

Certain embodiments of the present disclosure were described above. It is, however, expressly noted that implementation of the present disclosure is not limited to those embodiments, but rather additions and modifications to what was expressly described herein are also included within the scope of the disclosure. Thus, although embodiments of the present disclosure were described relating to modeling the effect(s) of a seismic load on a structure such as a nuclear reactor, and the critical components thereof, one of ordinary skill in the art will recognize that other embodiments may be used to model the nonlinearities of loads on dams, office buildings, military bases, sports arenas, bridges, utilities, mining infrastructure, and the like. Further, external loads within the scope of the invention include tornados, hurricanes, explosions, vibrations from automobile traffic, and the like.

Applications of the invention also go beyond structures, and may include medical applications, such as modeling bones and anatomy under stress, including for diagnostic purposes. Other benefits, uses and applications of embodiments also exist.

Moreover, it is to be understood that the features of the various embodiments described herein were not mutually exclusive and can exist in various combinations and permutations, even if such combinations or permutations were not made express herein, without departing from the scope of the disclosure. In fact, variations, modifications, and other implementations of what was described herein will occur to those of ordinary skill in the art without departing from the scope of the disclosure. As such, the invention is not to be defined only by the preceding illustrative description, but only by the claims which follow, and legal equivalents thereof.

Although each operation illustrated by or relating to FIGS. 1-9 and accompanying text recites acts performed in a particular order, embodiments of the present disclosure do not necessarily need to operate in that recited order. One of ordinary skill in the art would recognize many variations, including performing acts in parallel, or in a different order.

Additional non-limiting embodiments of the present disclosure, include:

Embodiment 1: A computer-implemented method of analyzing an effect of a load on a structure, the method comprising: providing a site model; providing a structure model; providing a site-structure interface model; receiving one or more parameters associated with at least one of the site model, the structure model, and the site-structure interface model; generating a combined model based at least in part on the site model, structure model, site-structure interface model and the one or more parameters that models at least one of a geometric and a non-linear behavior; and generating a response associated with the combined model based on an external load.

Embodiment 2: The computer-implemented method of embodiment 1, further comprising generating one or more force histories from one or more acceleration histories of a site.

Embodiment 3: The computer-implemented method of embodiment 1, wherein the external load is a hurricane.

Embodiment 4: The computer-implemented method of embodiment 1, wherein the external load is a tornado.

Embodiment 5: The computer-implemented method of embodiment 1, wherein the external load is an explosion.

Embodiment 6: The computer-implemented method of embodiment 1, wherein the external load is traffic vibrations.

Embodiment 7: The computer-implemented method of embodiment 1, wherein the structure model is associated with a nuclear reactor.

Embodiment 8: The computer-implemented method of embodiment 1, wherein the structure model is associated with a skyscraper.

Embodiment 9: The computer-implemented method of embodiment 1, wherein the structure model is associated with a dam.

Embodiment 10: The computer-implemented method of embodiment 1, wherein the structure model is associated with a bridge.

Embodiment 11: The computer-implemented method of embodiment 1, wherein the structure model is associated with a sports arena.

Embodiment 12: The computer-implemented method of embodiment 1, wherein the structure model is associated with a military base.

Embodiment 13: The computer-implemented method of embodiment 1, wherein the structure model is associated with a office building

Embodiment 14: The computer-implemented method of embodiment 1, wherein the structure model is associated with a utility facility.

Embodiment 15: The computer-implemented method of embodiment 1, wherein the structure model is associated with a mining infrastructure.

Embodiment 16: A computer system adapted to model an effect of a load on a patient, the computer system comprising: at least one processing core; and at least one non-transitory storage medium including software instructions adapted to enable the computer system to: provide a model of an anatomy of interest; provide a model of at least part of the body that includes the anatomy of interest; provide an interface model of the region where the body and the anatomy of interest interface; receive one or more parameters associated with at least one of the model of the anatomy of interest, model of at least a part of the body, and the interface model; generate a combined model based at least in part on the model of the anatomy of interest, model of at least a part of the body, the interface model 1 and the one or more parameters; and generate diagnostic information about the anatomy of interest based on a load and the combined model.

Embodiment 17: The computer system of embodiment 16, wherein the anatomy of interest is a bone.

Embodiment 18: The computer system of Embodiment 17, wherein the bone is a skull.

Embodiment 19: The computer system of embodiment 16, wherein the anatomy of interest is a heart.

Embodiment 20: The computer system of embodiment 16, wherein the anatomy of interest is a brain.

Embodiment 21: The computer system of embodiment 16, wherein the anatomy of interest is a liver.

Embodiment 22: The computer system of embodiment 16, wherein the anatomy of interest is a kidney.

Embodiment 23: The computer system of embodiment 16, wherein the anatomy of interest is an eye.

Embodiment 24: The computer system of embodiment 16, further comprising generating the model of the anatomy of interest from a preoperative image of a patient.

Embodiment 25: The computer system of embodiment 16, further comprising generating the model of the part of the body from a preoperative image of a patient.

Embodiment 26: A computer system adapted to analyze an effect of a load on a structure, the computer system comprising: at least one processing core; and at least one non-transitory storage medium including software instructions adapted to enable the computer system to: provide a site-structure interface model; and generate a response associated with the structure based on the site-structure interface model and an external load.

Embodiment 27: A method of modeling a load, the method comprising: determining at least one effect of a load based on at least one of a non-linear material behavior or a nonlinear geometric behavior.

Embodiment 28: A system adapted to analyze an effect of a load on a structure, the system comprising: a calibration engine adapted to receive one or more parameters generate model calibration settings based on the one more parameters; a model construction engine adapted to generate one or more models of non-linear behavior of a structure based on the model calibration settings; and an analysis engine adapted to generate response date based on the generated models and a load.

Embodiment 29: The system of embodiment 28, further comprising a communication network facilitating communication among the calibration engine, model construction engine, and analysis engine.

We claim:

1. A computer system adapted to analyze an effect of a load on a structure, the computer system comprising:
at least one processor; and
at least one computer-readable non-transitory storage medium including software instructions adapted to enable the computer system to:
provide a site model;
provide a structure model;
provide a site-structure interface model;
receive one or more parameters associated with at least one of the site model, the structure model, and the site-structure interface model;
generate a combined model based at least in part on the site model, structure model, site-structure interface model and the one or more parameters; and
generate a response associated with the combined model based on an external load.

2. The computer system of claim 1, wherein the software instructions are further adapted to enable the computer system to:
receive one or more properties corresponding to a site;
generate one or more finite soil elements based on the site properties, an element size, and a frequency cut-off; and
mesh the one or more finite soil elements to generate the site model.

3. The computer system of claim 2, wherein the one or more site properties are embodied in a cross-sectional image of the site.

4. The computer system of claim 2, wherein the one or more site properties comprise soil properties corresponding to the site.

5. The computer system of claim 1, wherein the external load is based on at least one of a seismic force history for a site associated with the site model and an impulse force associated with an earthquake source.

6. The computer system of claim 1, wherein the software instructions are further adapted to enable the computer system to generate one or more seismic force histories from one or more acceleration histories of a site associated with the site model.

7. The computer system of claim 1, wherein the software instructions are further adapted to enable the computer system to import one or more of the site model, the structure model, and the site-structure interface model.

8. The computer system of claim 1, wherein the combined model is a nonlinear soil-structure interaction model.

9. The computer system of claim 1, wherein the combined model comprises at least one of a non-linear material behavior and a nonlinear geometric behavior.

10. The computer program product of claim 1, wherein the generated response is in the frequency domain or the time domain.

11. A computer program product for enabling a computer to analyze an effect of a load on a structure, the computer program product comprising:
a computer-readable non-transitory memory; and
software instructions on the memory adapted to enable a computer to perform the operations of:
provide a site model;
provide a structure model;
provide a site-structure interface model;
receive one or more parameters associated with at least one of the site model, the structure model, and the site-structure interface model;
generate a combined model based at least in part on the site model, structure model, site-structure interface model and the one or more parameters; and
generate a response associated with the combined model based on an external load.

12. The computer program product of claim 11, wherein the software instructions on the memory are further adapted to enable a computer to present a graphical user interface at a display, the graphical user interface comprising regions that display information associated with the site model, structure model, site-structure interface model, the combined model, and the generated response.

13. A user-interface for facilitating user interaction with a computer system to analyze an effect of a load on a structure, the user interface invocable by an application program adapted to control the user interface based on user manipulation of the user interface, the user interface comprising:
one or more display regions, comprising:
one or more selectable site parameters;
one or more selectable structure parameters;
one or more selectable site-structure interface parameters;
one or more selectable load parameters; and
a response information based on a response analysis; and
one or more activatable regions that upon activation invoke the response analysis based on an activated region, selected site parameters, selected structure parameters, selected site-structure interface parameters, and selected load parameters.

14. The user-interface of claim 13, wherein the activated region corresponds to a component of a structure.

15. The user-interface of claim 13, wherein the one or more display regions further comprise information about a combined model, the combined model based on the selected site parameters, selected structure parameters, and selected site-structure interface parameters.

16. The user-interface of claim 15, wherein the displayed information about the combined model comprises a graphical representation of a site and a structure.

17. The user-interface of claim 16, wherein the graphical representation of the combined model comprises at least one of the activatable regions.

18. The user-interface of claim 14, wherein the response information comprises a graphical representation of at least one of a material non-linear response and a geometric nonlinear response of a structure.

19. The user-interface of claim 18, wherein the graphical representation of the response information comprises a displacement in the time domain.

20. The user-interface of claim 18, wherein the graphical representation of the response information comprises a displacement in the frequency domain.

21. The user-interface of claim 13, wherein the application program is a web-application or a client-application executing in a browser.

22. The user-interface of claim 13, wherein the application program is configured to control the user-interface such that at least two display regions are displayed contemporaneously.

23. The user-interface of claim 13, wherein the application program is configured to control the user-interface such that the display regions are added and removed from the user interface according to a workflow.
